(19) United States
(12) Patent Application Publication
(10) Pub. No.: US 2025/0079935 A1
(43) Pub. Date: Mar. 6, 2025

(54) GENERATOR ASSEMBLY AND METHOD FOR ATTACHING GENERATOR ASSEMBLY TO AN ENGINE

(71) Applicant: FCA US LLC, Auburn Hills, MI (US)

(72) Inventor: Steven S. Hagopian, Commerce Township, MI (US)

(21) Appl. No.: 18/458,361

(22) Filed: Aug. 30, 2023

(51) Int. Cl. H02K 7/18; F02B 63/04; H02K 7/075

(52) U.S. Cl. CPC H02K 7/1815; F02B 63/042; H02K 7/075

(57) ABSTRACT

A vehicle that includes an engine including a rotatable crankshaft, a transfer shaft attached to the crankshaft so as to be rotatable with the rotatable crankshaft, and a generator coupled to the engine via the transfer shaft. The generator includes a rotor attached to a rotor shaft and a stator located proximate the rotor, and the rotor shaft is attached to the transfer shaft so as to be rotatable along with the crankshaft and the transfer shaft, wherein the generator includes a casing including a first end attached to the engine and an opposite second end that defines an opening positioned proximate a location where the rotor shaft is attached to the transfer shaft; and the opening is closed by a removable access panel.

### FIELD

The present disclosure relates to a generator assembly and a method for attaching the generator assembly to an engine.

### BACKGROUND

This section provides background information related to the present disclosure which is not necessarily prior art.

FIG. 3 is a schematic illustration of a conventional connection between a generator 10 and an engine 12. Engine 12 includes a crankshaft 14 having a flange 16 including a mating feature in the form of a protrusion 18 that mates with a rotor shaft 20 of generator 10. Rotor shaft 20 includes a flanged end 22 having a mating feature in the form of a recess 24 that mates with protrusion 18. A rotor 26 is attached to rotor shaft 20 and a stator 28 is located radially outward from rotor 26. Due to the connection between crankshaft 14 and rotor shaft 20, the rotation of crankshaft 14 will in turn rotate rotor shaft 20 and rotor 26 relative to stator 28 to create electricity. A generator housing 30 may be attached to engine 12 via an adaptor plate 32 by fasteners 34. A radial shaft seal 36 may be positioned between generator housing 30 and rotor shaft 20 to prevent the intrusion of dust or moisture into an interior of generator housing 30.

The attachment between generator 10 and engine 12 in FIG. 1 requires a complicated and time-consuming process that requires multiple special tools and process steps. Due to the need for multiple special tools and process steps, the process of attaching generator 10 to engine 12 is very inefficient from an installation standpoint and also from a servicing standpoint. In this regard, the mating between the crankshaft protrusion 18 and the recess 24 of the rotor shaft 20 is conducted blindly. Due to the blind assembly process, special assembly tools are required to keep the rotor shaft 20 centered in the generator housing 30 prior to being bolted to the crankshaft 14. This process is cumbersome and is challenging for the installer to complete in a reasonable time. Accordingly, there is a need for an improved connection between the generator 10 and the engine 12.

### SUMMARY

This section provides a general summary of the disclosure and is not a comprehensive disclosure of its full scope or all of its features.

According to a first aspect of the present disclosure, there is provided a vehicle that includes an engine including a rotatable crankshaft; a transfer shaft attached to the crankshaft so as to be rotatable with the rotatable crankshaft; and a generator coupled to the engine via the transfer shaft, the generator including a rotor attached to a rotor shaft and a stator located proximate the rotor, the rotor shaft being attached to the transfer shaft so as to be rotatable along with the crankshaft and the transfer shaft, wherein the generator includes a casing including a first end attached to the engine and an opposite second end that defines an opening positioned proximate a location where the rotor shaft is attached to the transfer shaft; and the opening is closed by a removable access panel.

According to the first aspect, the crankshaft includes a radially outwardly extending flange defining a first mating feature and the transfer shaft includes a proximate end that includes a connection flange defining a second mating feature that corresponds to and mates with the first mating feature.

According to the first aspect, the transfer shaft includes a distal end defining a plurality of first splines that are configured to mate with a plurality of second splines formed on the rotor shaft.

According to the first aspect, there is also provided a crimp nut that fixes the rotor shaft to the transfer shaft.

According to the first aspect, the rotor shaft includes a first leg located proximate the connection flange that extends axially away from the connection flange, an opposite second leg located proximate the distal end of the transfer shaft that extends axially toward the connection flange, a first disc extending radially outward from the first leg, a second disc extending radially outward from the second leg, and a cylindrical section that connects the first disc to the second disc, the second splines being located on the second leg.

According to the first aspect, there is also provided an annular shaft seal connected to the first leg between the first leg and the casing.

According to the first aspect, there is also provided a static seal between the first leg and the transfer shaft.

According to a second aspect of the present disclosure, there is provided a method for attaching a generator to a crankshaft of an engine. The generator includes a casing that includes an opening that is covered by a removable access panel and houses a hollow rotor shaft, a rotor, and a stator. The method includes attaching a transfer shaft to the crankshaft; removing the access panel from the casing to expose the opening and enable viewing of transfer shaft through the hollow rotor shaft; manipulating the generator such that the transfer shaft passes through and mates with the hollow rotor shaft; fixing the transfer shaft to the hollow rotor shaft with a nut; attaching the casing to the engine to fix the generator to the engine; and re-attaching the access panel to the casing to close the opening.

According to the second aspect, the crankshaft includes a radially outwardly extending flange defining a first mating feature and the transfer shaft includes a proximate end that includes a connection flange defining a second mating feature that corresponds to the first mating feature, and the step of attaching the transfer shaft to the crankshaft includes mating the first mating feature with the second mating feature and fixing the transfer shaft to the crankshaft with a plurality of fasteners.

According to the second aspect, the transfer shaft includes a distal end defining a plurality of first splines and the rotor shaft includes a plurality of second splines, and mating of the transfer shaft with the rotor shaft includes engaging the first splines with the second splines.

According to the second aspect, the engine includes a plurality of alignment pins that are configured to mate with slots formed in the casing, and the step of attaching the casing to the engine includes mating the slots with the alignment pins.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a vehicle including an engine and a generator attached to the engine;

FIG. 2 is a schematic cross-sectional view of an attachment between a generator and an engine according to a principle of the present disclosure;

FIG. 3 is a schematic cross-sectional view of a conventional attachment between a generator and an engine; and

FIG. 4 illustrates various steps according to a method of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

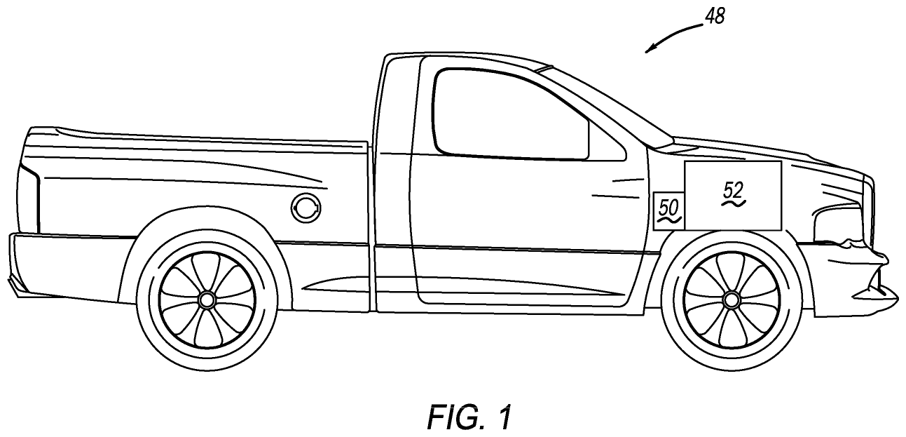

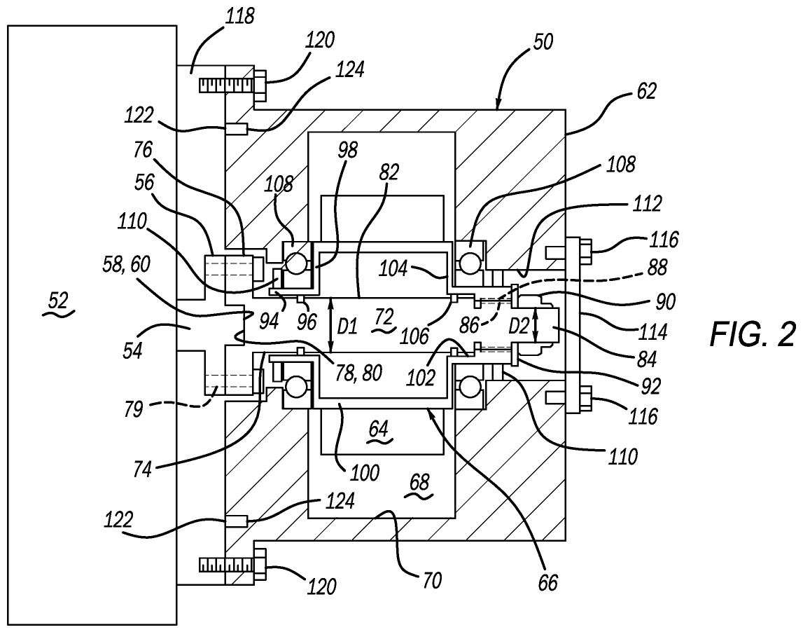

Referring to FIGS. 1 and 2, FIG. 1 illustrates an example vehicle 48 including an engine 52 that includes a generator 50 and FIG. 2 illustrates a connection between generator 50 and engine 52 according to the present disclosure. Engine 52 may be an internal combustion engine that includes a crankshaft 54. Crankshaft 54 may have an outwardly extending flange 56 that defines a mating feature 58, which in the illustrated embodiment is an axially outwardly extending protrusion 60. Flange 56 may be unitary with crankshaft 54, or may be a separate component that is fixed to crankshaft 54 by welding or by using fasteners (not shown). Protrusion 60 may have any shape known to one skilled in the art. For example, protrusion 60 may be round (e.g., disc-shaped), hexagonally shaped, or square.

Generator 50 includes a housing or casing 62 which is configured to cover components of generator 50. In the illustrated embodiment, generator 50 includes a rotor 64 connected to a rotor shaft 66. A stator 68 including windings (not shown) is located radially outward from rotor 64 and is fixed to an interior surface 70 of casing 62. Rotor shaft 66, in accordance with the present disclosure, is connected to a transfer shaft 72 that is coupled to crankshaft 54.

Transfer shaft 72 includes a proximate end 74 that defines a connection flange 76 that is configured to be attached to the outwardly extending flange 56 of crankshaft 54 using fasteners 79. Connection flange 76 defines a mating feature 78, which in the illustrated embodiment is defined by a recess 80 that is configured for receipt of mating feature 58, and is shaped to correspond to the shape of mating feature 58. An elongated shaft 82 extends axially outward from connection flange 76 and includes a distal end 84 that includes a plurality of first splines 86 that are configured to mate with second splines 88 that are formed on rotor shaft 66. In the illustrated embodiment, elongated shaft 82 includes a diameter D1 that is greater than a diameter D2 of distal end 84. It should be understood, however, that diameter D2 of distal end 84 may be equal to diameter D1, if desired. Distal end 84 may include a threaded surface (not shown) axially outboard from first splines 86 that are configured to mate with another threaded surface (not shown) of a crimped nut 90 that secures engagement between transfer shaft 72 and rotor shaft 66. A washer 92 may be located between first splines 86 and nut 90. As will be described in more detail later, the use of transfer shaft 72 substantially reduces the time needed to connect generator 50 to engine 52.

Rotor shaft 66 is a cylindrical structure including a first end or leg 94 located proximate connection flange 76. First end 94 extends axially along transfer shaft 72 and is separated from transfer shaft 72 by a first static seal 96 located between transfer shaft 72 and first end 94 that may be, for example, an O-ring. First end 94 is connected to a first radially outwardly extending disc 98. A cylindrical section 100 is connected to first outwardly extending disc 98 that extends axially away from first radially outwardly extending disc 98. A second end or leg 102 is located distal from first end 94 that includes second splines 88. Second end 102 extends axially back from nut 90 toward a second outwardly extending disc 104 that is connected to and between each of cylindrical section 100 and second end 102. A second static seal 106 (e.g., O-ring) may be positioned between transfer shaft 72 and second end 102.

A pair of bearings 108 may be positioned between casing 62 and the first and second ends 94 and 102 for rotatably supporting rotor shaft 66 relative to casing 62. In addition, annular shaft seals 110 may be located outboard from bearings 108 that are fixed to the casing 62 and seal the interface between casing 62 and rotor shaft 66.

Lastly, it can be seen that casing 62 includes an opening 112 at a location proximate distal end 84 of transfer shaft 72 that may be covered by an access cover 114 that may be attached to casing 62 using fasteners 116. Opening 112 permits an installer to peer through generator 50 when installing generator 50 to transfer shaft 72, which results in a quicker installation because the connection between generator 50 and engine 52 is no longer blind. After generator 50 has been coupled to transfer shaft 72, access cover 114 can be fastened to casing 62 using the fasteners 116, and then casing 62 can be attached to engine 52 via an optional adapter plate 118 using fasteners 120.

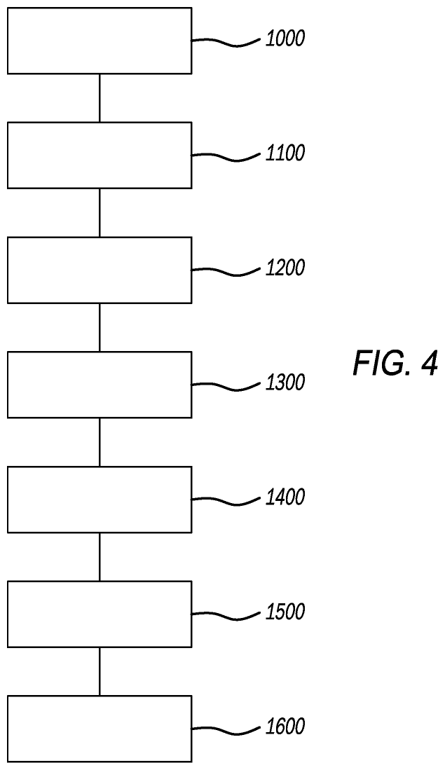

More specifically, referring to FIG. 4, to attach generator 50 to engine 52, transfer shaft 72 is first attached to crankshaft 54 of engine 52 (step 1000). That is, the mating feature 78 of connection flange 76 is mated with the mating feature 58 of outwardly extending flange 56 of crankshaft 54, and then connection flange 76 is fixed to outwardly extending flange 56 using fasteners 78.

Next, the access panel 114 of casing 62 is removed to expose opening 112 of casing 62 (step 1100). When access panel 114 is removed and because rotor shaft 66 is hollow, the installer of generator 50 to engine 52 is able to view the transfer shaft 72 connected to crankshaft 54. In addition, alignment pins 122 may be provided on adapter plate 118 (or engine 52, if adapter plate 118 is omitted) that are configured to mate with slots 124 formed in casing 62. Thus, while viewing transfer shaft 72, the installer is able to manipulate generator 50 relative to transfer shaft 72 such that transfer shaft 72 passes through the hollow rotor shaft 66 and first splines 86 and second splines 88 become mated (step 1200). Further, generator 10 may be manipulated to mate pins 122 with slots 124 (step 1300).

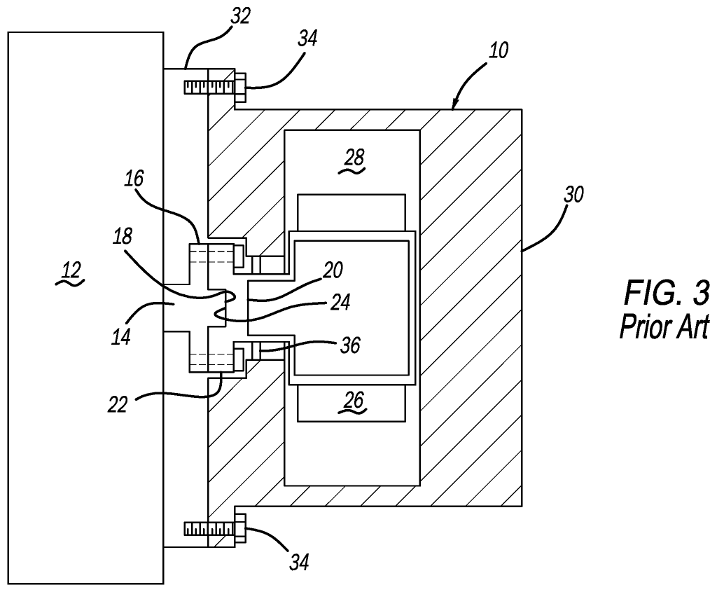

Once first splines 86 are mated with second splines 88 and pins 122 are mated with slots 124, the installer may then locate washer 92 over distal end 84 of transfer shaft 72 and nut 90 may be threadingly engaged with distal end 84 of transfer shaft to rotatably couple transfer shaft 72 to rotor shaft 66 (step 1400). Moreover, fasteners 120 are used to fix casing 62 to adapter plate 118 (or engine 52 if adapter plate 118 is omitted) (step 1500). After generator 50 is fixed to engine 52, the installer may finally close opening 88 by attaching access panel 114 to casing 62 using fasteners 116 (step 1600). Installation of generator 50 on engine 52, therefore, is substantially easier than attempting a blind installation like that shown in FIG. 3.

If generator 50 is to be serviced, the serviceman removes access cover 114 to expose nut 90 to disengage rotor shaft 66 from transfer shaft 72. Then, casing 62 can be detached from engine 52 (or adapter plate 118) by removing fasteners 120 and pulling on casing 62 to disengage casing 62 and the other components of generator 50 from engine 52. Thus, the configuration of the present application is also much easier to service in comparison to the configuration of FIG. 3, which requires special tools.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an engine including a rotatable crankshaft;
a transfer shaft attached to the crankshaft so as to be rotatable with the rotatable crankshaft; and
a generator coupled to the engine via the transfer shaft, the generator including a rotor attached to a rotor shaft and a stator located proximate the rotor, the rotor shaft being attached to the transfer shaft so as to be rotatable along with the crankshaft and the transfer shaft,
wherein the generator includes a casing including a first end attached to the engine and an opposite second end that defines an opening positioned proximate a location where the rotor shaft is attached to the transfer shaft; and
the opening is closed by a removable access panel.

2. The vehicle according to claim 1, wherein the crankshaft includes a radially outwardly extending flange defining a first mating feature and the transfer shaft includes a proximate end that includes a connection flange defining a second mating feature that corresponds to and mates with the first mating feature.

3. The vehicle according to claim 2, wherein the transfer shaft includes a distal end defining a plurality of first splines that are configured to mate with a plurality of second splines formed on the rotor shaft.

4. The vehicle according to claim 3, further comprising a crimp nut that fixes the rotor shaft to the transfer shaft.

5. The vehicle according to claim 3, wherein the rotor shaft includes a first leg located proximate the connection flange that extends axially away from the connection flange, an opposite second leg located proximate the distal end of the transfer shaft that extends axially toward the connection flange, a first disc extending radially outward from the first leg, a second disc extending radially outward from the second leg, and a cylindrical section that connects the first disc to the second disc, the second splines being located on the second leg.

6. The vehicle according to claim 5, further comprising an annular shaft seal connected to the first leg between the first leg and the casing.

7. The vehicle according to claim 5, further comprising a static seal between the first leg and the transfer shaft.

8. A method for attaching a generator to a crankshaft of an engine, the generator including a casing that includes an opening that is covered by a removable access panel and houses a hollow rotor shaft, a rotor, and a stator, the method comprising:
attaching a transfer shaft to the crankshaft;
removing the access panel from the casing to expose the opening and enable viewing of transfer shaft through the hollow rotor shaft;
manipulating the generator such that the transfer shaft passes through and mates with the hollow rotor shaft;
fixing the transfer shaft to the hollow rotor shaft with a nut;
attaching the casing to the engine to fix the generator to the engine; and
re-attaching the access panel to the casing to close the opening.

9. The method according to claim 9, wherein the crankshaft includes a radially outwardly extending flange defining a first mating feature and the transfer shaft includes a proximate end that includes a connection flange defining a second mating feature that corresponds to the first mating feature, and the step of attaching the transfer shaft to the crankshaft includes mating the first mating feature with the second mating feature and fixing the transfer shaft to the crankshaft with a plurality of fasteners.

10. The method according to claim 9, wherein the transfer shaft includes a distal end defining a plurality of first splines and the rotor shaft includes a plurality of second splines, and mating of the transfer shaft with the rotor shaft includes engaging the first splines with the second splines.

11. The method according to claim 8, wherein the engine includes a plurality of alignment pins that are configured to mate with slots formed in the casing, and the step of attaching the casing to the engine includes mating the slots with the alignment pins.
